(19) United States
(12) Patent Application Publication
(10) Pub. No.: US 2004/0111967 A1
(43) Pub. Date: Jun. 17, 2004

(54) Preformed container for growing flowering plant bulbs

(76) Inventors: William R. Raap, Shelburne, VT (US); Lynette N. Raap, Shelburne, VT (US)

Correspondence Address: DOWNS RACHLIN MARTIN PLLC, 199 MAIN STREET, P O BOX 190, BURLINGTON, VT, 05402-0190, US

(21) Appl. No.: 10/695,220

(22) Filed: Oct. 28, 2003

Related U.S. Application Data
(60) Provisional application No. 60/421,655, filed on Oct. 28, 2002.

(51) Int. Cl. A01G 23/02

(52) U.S. Cl. 47/74

(57) ABSTRACT

A container (10) having a bottom wall (30) and a freestanding sidewall (34) defining a cavity (38) for receiving soil (14) and plant bulbs (18) planted in the soil. The container is made of biodegradable materials and is designed to be buried in soil (26) located in, e.g., a flower bed or a container. The container may optionally include any one or more of a rodent deterrent (46) attached to its exterior surface, a growth enhancer (66) attached to its interior surface and a closure (50) for sealing the cavity containing the bulbs. The container allows bulbs to be planted densely in a small space, while protecting them from rodents and enhancing their long-term health and viability.

### RELATED APPLICATION DATA

This application claims the benefit of priority of U.S. Provisional Patent Application Serial No. 60/421,655, filed Oct. 28, 2002, and entitled “Preformed Bed for Flower Bulbs,” that is incorporated by reference herein in its entirety.

### FIELD OF THE INVENTION

The present invention is generally related to the field of horticulture. In particular, the present invention is directed to a preformed container for growing flowering plant bulbs.

### BACKGROUND OF THE INVENTION

Flowering bulb plants are popular for many applications, including perennial gardens, landscaping and other ornamental beds and living flower arrangements and other containerized plantings, among others. However, the proper cultivation of flowering plant bulbs requires attention to a number of factors. These factors include planting depth, protection from rodents, nutrition, hydration and arrangement, among others.

Bulbs of each variety of flowering bulb plants generally have an optimal planting depth, and this depth often varies among different varieties. Although pre-packaged bulbs are often sold in packages that indicate the optimal planting depth for the particular variety of bulbs contained in the packages, inexperienced, casual or inattentive gardeners often neglect to heed these indications and end up planting the bulbs at an improper depth. Bulbs planted at an improper depth can result in deviations from proper plant growth and, in extreme cases, no growth at all.

Flowering plant bulbs planted in outdoor beds are particularly susceptible to attack by burrowing rodents. Rodents, such as voles, moles, chipmunks and squirrels, among others, enjoy eating many varieties of bulbs in situ, often killing the plants or destroying the ability of the bulbs to sprout when the bulbs are attacked while dormant.

Flowering bulb plants, like all plants, require proper nutrition and hydration in order to grow properly and thrive. While seasoned gardeners will typically take the time to ensure the bulbs they plant are properly nourished and hydrated, other gardeners may not. For example, such other gardeners may plant bulbs in un-amended poor quality soil and/or water the bulbs infrequently, if at all, hoping for the best. However, such inattentiveness often leads to malnourished and malhydrated plants that do not grow to their full potential. Also, some flowering plant bulbs, such as tulip bulbs, lose vigor faster if they are poorly planted, and they will flower for fewer years than well-planted bulbs.

Some gardeners may enjoy the look of clusters containing multiple varieties of bulbs but do not have the inclination or time to arrange such clusters either as to planting depth or optimal spacing between bulbs. Therefore, these gardeners may avoid using these clusters in their own gardening efforts.

What is needed is a device that can assist a gardener in: planting bulbs at the optimal depth; planting bulbs at optimal spacing; protecting bulbs from rodents; providing bulbs with proper nutrition and hydration and arranging bulbs, among other things.

### SUMMARY OF THE INVENTION

In one aspect, the present invention is directed to a device for planting a plurality of bulbs of plants. The device comprises a container having an exterior and including a bottom wall and a sidewall extending upward from the bottom wall and defining an opening. A rodent deterrent secured to at least a portion of the exterior of the container.

In another aspect, the present invention is directed to a container for containing soil and a plurality of bulbs of plants. The device comprises a preformed freestanding wall made of a biodegradable material and defining a cavity for receiving the plurality of bulbs. A growth-enhancer is attached to the wall for enhancing the growth of the plants sprouting from the plurality of bulbs.

In yet another aspect, the present invention is directed to a method of planting a cluster of flowering bulb plants. The method comprises the step of providing an assembly comprising a container that includes a preformed freestanding wall comprising a biodegradable material. The container has a cavity. A first soil contained in the cavity. A plurality of plant bulbs are planted in the first soil. The method further comprises the step of planting the assembly in a second soil.

### BRIEF DESCRIPTION OF THE DRAWINGS

For the purpose of illustrating the invention, the drawings show a form of the invention that is presently preferred. However, it should be understood that the present invention is not limited to the precise arrangements and instrumentalities shown in the drawings, wherein:

FIG. 1 is an exploded perspective view of a preformed container of the present invention; and

FIG. 2 is an elevational cross-sectional view of the preformed container of FIG. 1 illustrating the preformed container planted with flowering plant bulbs and buried in soil.

### DETAILED DESCRIPTION OF THE DRAWINGS

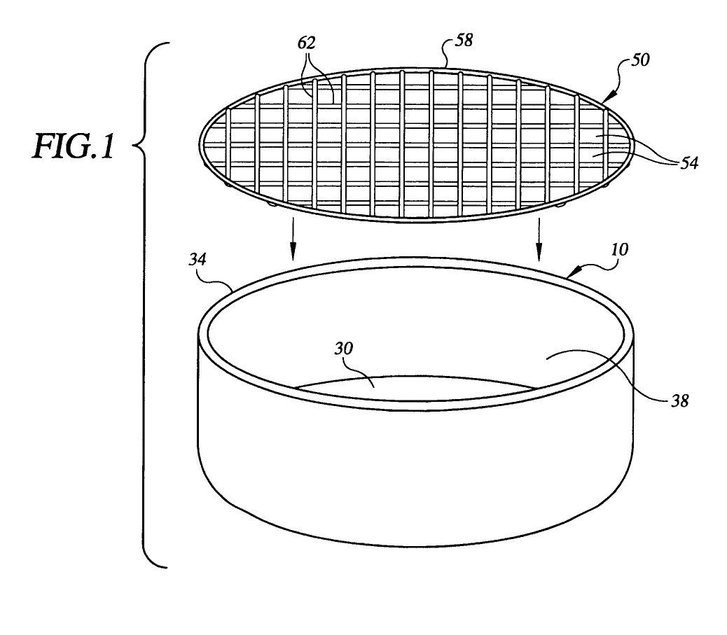

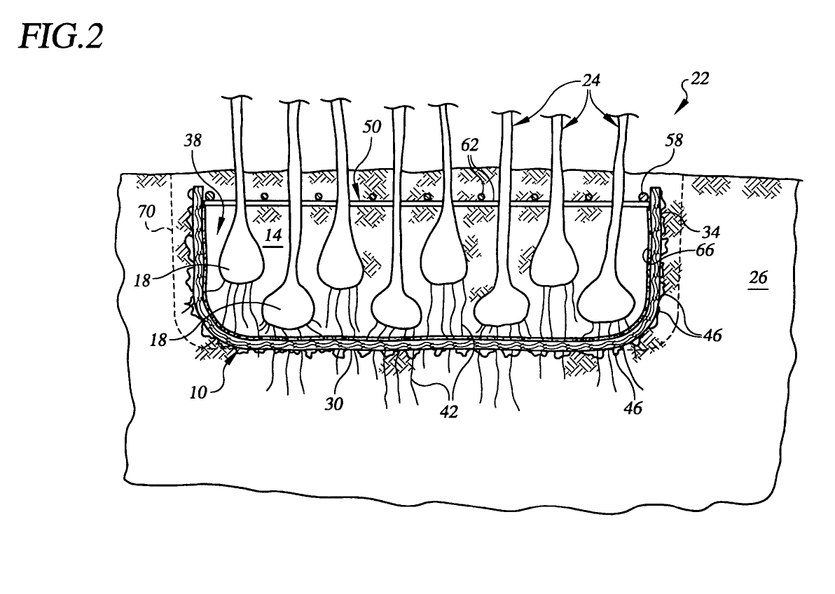

Referring to the drawings, FIGS. 1 and 2 show in accordance with the present invention a preformed container, which is generally denoted by the numeral 10. Container 10 may be used for containing a soil 14 and a plurality of flowering plant bulbs 18 planted therein so that a cluster 22 of plants 24 sprouting from the bulbs is formed. Container 10 is unique in that it allows bulbs 18 to be planted densely in a small space, while protecting them from rodents and enhancing their long-term health and viability. Container 10 may be buried in existing soil 26, such as soil within a garden, landscaping or other ornamental bed or living flower arrangements or other containerized plantings, among others. Container 10 also facilitates multi-level planting of both same and different varieties of bulbs 18. (Typically, larger bulbs are planted deeper than smaller bulbs.) Bulbs 18 may be planted at their optimal depth so as to give plants 24 the best opportunity to grow to their full potential. An end result of using container 10 of the present invention is that it allows for forming an explosion of blooms in a very limited space that can be sequenced by the proper selection of varieties of bulbs 18 to create flower bulb bouquets that bloom for an extended period of time.

Container 10 generally includes a bottom wall 30 and a sidewall 34 that define a cavity 38 for receiving soil 14 (FIG. 2) and a collection of bulbs 18 (FIG. 2) planted in the soil. The plan area of bottom wall 30 may have any dimensions desired that typically, but not necessarily, will be selected based upon the desired number and sizes of bulbs 18 in the one or more layers of such bulbs, the planting distance between adjacent bulbs and the desired size of cluster 22. Sidewall 34 may have any height desired and may be freestanding when container 10 is resting upright and is empty. Typically, but not necessarily, the height of sidewall 34 will depend on planting-depth requirements for the particular variety(ies), and number of layers, of bulbs 18 in container 10. The thickness of bottom wall 30 and/or sidewall 34 are typically configured to allow roots 42 of bulbs 18 to penetrate therethrough as they grow, e.g., by providing apertures or other passageways for the roots to grow through. Although container 10 is shown in the drawings as being generally circular in shape, those skilled in the art will appreciate that the container may have virtually any shape desired, such as polygonal, oval or irregular, among others.

Walls 30, 34 may comprise a biodegradable material, e.g., natural plant fibers. When plant fibers are used, relative coarse, stiff fibers, such as coir (fibers from the outer husks of coconuts) are generally, but not necessarily, preferred over more flexible fibers such as jute, flax and cotton because they last several years in the soil, but ultimately break down into soil enhancing organic matter. Relatively stiff, and relatively large fibers can allow sidewalls 34 to be made relatively thin yet self-supporting, i.e., freestanding. Coir fibers are generally on the order of 0.01-0.02 inch (0.25-0.50 mm) in diameter and from 1-3 inches long (2.5-76 mm). The thinness achievable with such fibers can be exploited in designing bottom wall 30 and sidewall 34 to be penetrable by roots 42 of bulbs 18. For example, spaces between adjacent fibers may provide passageways that allow roots 42 of bulbs 18 to pass through bottom wall 30 and/or sidewall 34. In addition, these passageways allow for water to easily drain through walls 30, 34. Plants 24 typically grow best in moist, but not wet, soil. If an insufficient number of passageways are provided, container 10 will essentially act as a bowl to hold water that will tend to make bulbs 18 rot.

The plant fibers may be bonded together with a bonding agent (not shown), preferably a biodegradable bonding agent, such as latex rubber. The ratio of fibers to latex, or other bonding agent, is preferably, but not necessarily, selected to allow a sufficient number of passageways to form within walls 30, 34 to allow for proper drainage of excess water from cavity 38. For example, a ratio on the order of ten parts coir to one part latex provides a sufficient amount of bonding agent to bind the fibers together, but not create a substantially passageway-free watertight container. Walls 30, 34 of container 10 generally inhibit too much moisture in soil 14 within cavity 38 from migrating laterally and downward, thereby making more moisture available for keeping flowering plants 24 properly hydrated. When walls 30, 34 contain plant fibers, these fibers typically absorb and retain moisture that further aids the hydration of flowering plants 24.

Container 10 may be made using any suitable fabrication process, such as a molding process utilizing a mold (not shown) having a pair of mold halves. The particular process used will depend upon the material(s) selected for making walls 30, 34 of container 10. For example, when walls 30, 34, are made of plant fibers and a bonding agent, a mixture of the plant fibers and uncured latex may be applied in a layer having a suitable thickness to an inverted mold half substantially shaped the same as cavity 38. Then a female mold half having substantially the same interior shape as the exterior of container 10 may be placed over this layer and the mold halves pressed together and the bonding agent allowed to cure. Once the bonding agent has cured, container 10 may be removed from the mold. Those skilled in the art will readily appreciate that such a molding process is only one of many ways of making container 10 of the present invention.

Optionally, container 10 may be provided with a rodent deterrent, such as a plurality of rigid structures 46 having relatively sharp edges and/or points. Structures 46 may be applied to the exterior surface of container 10, e.g., by adhesive bonding using a suitable adhesive (not shown), such as latex rubber. Fragments of seashells, which have been crushed to create sharp edges and are sufficiently strong to inhibit burrowing rodents, have been found to be particularly suitable for use as structures 46. In addition to deterring burrowing rodents from consuming/damaging bulbs located within cavity of container 10, the seashell fragments can also provide a source of natural calcium and phosphorus for bulbs. Calcium and phosphorous are recognized as beneficial nutrients for optimal growth performance of bulbs 18. Of course, crushed seashells are not the only material suitable for use as structures 46 for providing rodent deterrence. Other suitable materials include crushed stone or concrete, particularly where these materials are relatively hard.

To further discourage rodent damage, container 10 may also optionally be provided with a closure 50 for closing the opening formed by cavity 38. Closure 50 may include openings 54 to allow plants 24 growing from bulbs 18 to sprout through the closure. Closure 50 may be made of any suitable material that rodents cannot easily bite through, and openings 54 may be provided in any shape, size, number, and configuration suitable for the number, size, location and type(s) of plants 24 in the collection contained within container 10. Closure 50 illustrated is a metal grid comprising a circumferential support 58 and a plurality of wire cross-members 62 arranged in two directions perpendicular to one another, wherein the cross-members in each direction have a spacing of approximately one inch to form a grid containing mostly square openings 54. Cross members 62 are attached to circumferential support 58 and may also be secured to one another. Of course, many other types of construction are possible, such as molded grids or a solid sheet having regions cut out to form openings 54. In the embodiment shown, closure 50 sits atop soil 14 within container 10 when properly installed, but may alternatively engage container 10 or a closure support (not shown) in any suitable manner. When container 10 is buried as described below, closure 50 will typically be located beneath the surface of soil 26 in which the container is buried, e.g., one-quarter to two inches beneath the soil surface.

Container 10 may further optionally include a growth enhancer 66, such as a beneficial fungus, e.g., mycorrhizae fungus, which is known to enhance the growing environment and root development of plants and flower bulbs. Growth enhancer 66 may be provided in any suitable manner, such as applied to interior surface of bottom wall 30 and/or sidewall 34, or may be mixed into the material used to make container 10. As those skilled in the art will appreciate, conventional bulb fertilizer may also be used for growth enhancer 66.

Container 10 may be used in the methods described below. However, those skilled in the art will appreciate that the following descriptions are only general and that alternative methods may be used, depending upon the number and type of bulbs 18 used and planting conditions, among other things.

When container 10 has not been pre-planted with bulbs 18, the container may be used as follows. In this scenario, bulbs 18 may be obtained separately from container 10 or prepackaged therewith, but not in a planted form. First, a hole 70 is dug into existing soil 26 to a size appropriate for container 10 to essentially serve as a liner for the hole. Then, container 10 is sunk into hole 70. A portion of soil 14 may be placed at the bottom of container 10, e.g., as a first layer a depth of about one-half inch. If existing soil 26 in which hole 70 is dug is of a poor quality or essentially depleted of nutrients, soil 14 may be a different, nutrient-rich soil or, alternatively, may be an amended mixture of soil 26 and nutrient-rich soil and/or nutritional amendments, so as to create a better growing environment for bulbs 18. Bulbs 18 requiring the deepest planting depth may be placed in the bottom of container 10 generally upon the first layer of soil so as to form a first layer of bulbs. More soil 14 is added to cover the first layer of bulbs 18. If one or more additional layers of bulbs 18 are desired, these layers are added, with additional soil 14 being added after the addition of each layer. If optional closure 50 is used, it may then be placed atop the uppermost layer of soil 14 and/or bulbs 18 within container 10. Hole 70 may then be filled so that closure 50 is covered with, e.g., about one and one-half to two inches of soil 26, depending upon specific requirements for bulbs 18.

Container 10 alternatively may be pre-planted with a particular collection of bulbs 18 prior to installing the container into existing soil 26. If container 10 is pre-planted, it may include one or more layers of bulbs 18 planted therein in the manner described above in connection with the scenario wherein the bulbs are planted after the container has been sunk into suitable hole 70. Container 10 may be pre-planted with bulbs 18 prior to its installation into soil 26 by a consumer, by seller, who may sell pre-planted beds to wholesalers, retailers and/or directly to consumers, or by another. Pre-planted containers 10 may be offered for sale in any conventional manner, such as mail order or on-line catalogs, and shipped in any conventional manner, such as by private common carrier or government mail service, among others.

For a pre-planted container 10, generally the only steps that need to be performed to install the container are digging hole 70 into which the container will be installed, installing the pre-planted container into the hole and covering the pre-planted container with an appropriate thickness of soil 26. Of course, these steps are exclusive of watering, fertilizing and any other steps those skilled in the art may perform when planting flower bulbs 18.

Benefits of a preformed container of the present invention, e.g., container 10 of FIGS. 1 and 2, include:

creating an optimal growing environment for more successful long-term bulb flowering;

growing more bulbs more successfully in a smaller space;

protecting the environment by using a buriable container that will harmlessly biodegrade over time;

allowing pre-selection of bulb collections for the preformed containers to provide landscaping and color-blending solutions for customers; and

allowing predetermined bulb collections to be packed and shipped in the preformed containers, either planted or otherwise, directly to customers for easy delivery and planting.

Although the invention has been described and illustrated with respect to an exemplary embodiment thereof, it should be understood by those skilled in the art that the foregoing and various other changes, omissions and additions may be made therein and thereto, without parting from the spirit and scope of the present invention.

What is claimed is:

1. A device for planting a plurality of bulbs of plants, the device comprising:
(a) a container having an exterior and including a bottom wall and a sidewall extending upward from said bottom wall and defining an opening; and
(b) a rodent deterrent secured to at least a portion of said exterior of said container.

2. A device according to claim 1, further including a closure substantially closing said opening, said closure having a plurality of apertures configured to receive therethrough the plants that sprout from the plurality of bulbs.

3. A device according to claim 2, wherein said closure comprises a grid.

4. A device according to claim 1, wherein said rodent deterrent comprises seashell fragments.

5. A device according to claim 1, wherein said bottom wall and said sidewall each comprise elongate biodegradable fibers.

6. A device according to claim 5, wherein said elongate biodegradable fibers are bonded to one another with a bonding agent.

7. A device according to claim 6, wherein said bonding agent is latex rubber.

8. A device according to claim 5, wherein said elongate biodegradable fibers are coir.

9. A device according to claim 1, further comprising a growth-enhancer.

10. A device according to claim 8, wherein said growth-enhancer is a fungus.

11. A device according to claim 1, wherein the bulbs have roots and said wall is configured to allow the roots to penetrate therethrough when they grow.

12. A system for growing a plurality of bulb plants in a cluster in a first soil, comprising:
(a) a container comprising a preformed free-standing wall and defining a cavity, said freestanding wall comprising biodegradable fibers;
(b) a second soil contained within said cavity; and
(c) a plurality of bulbs of plants contained within said second soil.

13. A system according to claim 12, wherein said cavity has an opening and the system further includes a closure substantially closing said opening, said closure having a plurality of apertures configured to receive therethrough the plants that sprout from said plurality of bulbs.

14. A system according to claim 12, wherein said container has an exterior and the system further comprises a rodent deterrent attached to said exterior.

15. A system according to claim 12, wherein said biodegradable fibers are bonded to one another with a bonding agent.

16. A system according to claim 15, wherein said bonding agent is latex rubber.

17. A system according to claim 12, wherein said biodegradable fibers are coir.

18. A system according to claim 12, further comprising a growth-enhancer attached to said container for enhancing the growth of the plants sprouting from said plurality of bulbs.

19. A system according to claim 12, wherein said plurality of bulbs have roots and said container is configured to allow said roots to penetrate therethrough when said roots grow.

20. A container for containing soil and a plurality of bulbs of plants, comprising:
(a) a preformed freestanding wall made of a biodegradable material and defining a cavity for receiving the plurality of bulbs; and
(b) a growth-enhancer attached to said wall for enhancing the growth of the plants sprouting from the plurality of bulbs.

21. A container according to claim 20, wherein said growth-enhancer is ground-up seashells.

22. A container according to claim 20, wherein said growth-enhancer is a fungus.

23. A container according to claim 20, wherein said cavity has an opening and the system further includes a closure substantially closing said opening, said closure having a plurality of apertures configured to receive therethrough the plants that sprout from the plurality of bulbs.

24. A method of planting a cluster of flowering bulb plants, comprising the step of:
(a) providing an assembly comprising:
(i) a container that includes a preformed freestanding wall comprising a biodegradable material, said container having a cavity;
(ii) a first soil contained in said cavity; and
(iii) a plurality of plant bulbs planted in said first soil; and
(b) planting said assembly in a second soil.

25. A method according to claim 24, further comprising the step of deterring a rodent from accessing said cavity.

26. A method according to claim 24, wherein said cavity has an opening and the method further comprises the step of providing a closure that deters a rodent from entering said cavity through said opening.

27. A method according to claim 24, further comprising the step of releasing a growth enhancer from said container.

28. A method of selling a cluster of flowering plant bulbs, comprising the step of:
(a) providing an assembly comprising:
(i) a container that includes a preformed freestanding wall comprising a biodegradable material, said container having a cavity;
(ii) a first soil contained in said cavity; and
(iii) the cluster of flowering plant bulbs planted in said first soil; and
(b) offering said assembly for sale.

29. A method according to claim 28, wherein said container further comprises an exterior surface and the method further comprises the step of attaching a rodent deterrent to said exterior surface.

30. A method according to claim 28, wherein said cavity has an opening and the method further comprises the step of providing a closure that deters a rodent from entering said cavity through said opening.

31. A method according to claim 28, wherein said container has an interior surface and the method further comprises the step of attaching a growth enhancer to said interior surface.

32. A method according to claim 28, wherein step (b) includes offering the container for sale in a catalog and the method further includes the step of shipping the assembly to a purchaser.
